(19) United States
(12) Patent Application Publication
(10) Pub. No.: US 2015/0052077 A1
(43) Pub. Date: Feb. 19, 2015

(54) REVIEW TRANSPARENCY INDICATOR SYSTEM AND METHOD

(71) Applicant: Andrew C. Gorton, Kingston (JM)

(72) Inventor: Andrew C. Gorton, Kingston (JM)

(21) Appl. No.: 14/460,056

(22) Filed: Aug. 14, 2014

Related U.S. Application Data
(60) Provisional application No. 61/865,866, filed on Aug. 14, 2013.

(51) Int. Cl. G06Q 30/02; G06F 3/0481

(52) U.S. Cl. CPC G06Q 30/0282; G06F 3/0481
USPC 705/347

(57) ABSTRACT

A system and method are provided to include indicators on a website or within an application or publication to indicate a level of openness and level of independence for a review. The system may provide interaction with one or more online interfaces, such as pages provided by a website. The method may include analyzing the reviews; analyzing a level of independence indicative of influence on the review by a creator; analyzing a level of openness indicative of availability of the reviews to a third party user; calculating the transparency using the level of independence and the level of openness; and displaying the transparency as the indicator via the interface. The system and method may relate to an online marketplace.

### CROSS-REFERENCE TO RELATED APPLICATIONS

This application is a nonprovisional application of and claims priority from U.S. provisional patent application Ser. No. 61/865,866 filed on Aug. 14, 2013. The foregoing application is incorporated in its entirety herein by reference.

### FIELD OF THE INVENTION

The present invention relates to a review system. More particularly, the present invention relates to a review system with a transparency indicator.

### BACKGROUND

Online marketplaces often include consumer reviews of products and mercantile transactions. Review systems enable users to provide feedback on products and services offered for sale to assist other purchasers or offering parties to assess a perceived quality and popularity of products and services offered for sale. Typical independent review systems enable users to provide feedback relating to their transactions and experiences. However, such feedback is not generally controlled by the person or organization offering the product or service for sale or exchange. As such, unfavorable user feedback and reviews are disadvantageously not subject to edit or deletion by the selling party.

What is needed is a transparency review indicator system that enables a selling or offering party to provide accurate presentation of activity relating to review of products and services being sold, offered, or otherwise exchanged. What is needed is a system and method that transparently reflects the status of a review for a product or service and any revisions made to the same. What is needed is a system to indicate a level of transparency relating to reviews and ratings caused by a selling or offering party. What is needed is a system that can transparently present a modification history of one or more review or rating in an accessible and easily interpreted interface.

### SUMMARY

A system and method are provided to include a series of indicators on a website or within an application to indicate an extent by which a review or rating has been manipulated. The system may provide interaction with one or more online interfaces, such as pages provided by a website. The interface may include a page, column, or tab, and entries within the page, column, or tab, through which content may be viewed and/or commented. The system and method may also disclose whether the owner of the account, page, column, or tab has modified or deleted any comments by third parties. The indicators may include numbers, colors, visual cues, and other features that can vary in accordance to changes in the options available for the page, column, or tab in question and/or according to actions taken by the owner of the account, page, column, or tab.

The present invention provides a transparency review indicator system that enables a selling or offering party to provide an accurate presentation of activity relating to review of products and services being sold, offered, or otherwise exchanged. The present invention provides a system and method that transparently reflects the status of a review for a product or service and any revisions made to the same. The present invention provides a system to indicate a level of transparency relating to reviews and ratings caused by a selling or offering party. The present invention provides a system that can transparently present a modification history of one or more review or rating in an accessible and easily interpreted interface.

According to an embodiment of the present invention, a system is provided for indicating transparency of a review that includes an interface and an indicator. The indicator may include a first indication and a second indication being displayed by the interface to reflect the transparency of the review. The first indication may signify a level of openness. The second indication may signify a level of independence. The system is operable on a computerized device with a processor and memory.

In another aspect, the review may be manipulable by a creator. The level of independence may be indicative of the influence on the review by the creator.

In another aspect, the indicator is determinable by performing the steps: (a) analyzing the review; (b) analyzing the level of independence; (c) analyzing the level of openness; (d) calculating the transparency using the level of independence and the level of openness; and (e) displaying the transparency as the indicator via the interface.

In another aspect, the level of openness may be indicative of availability of the review to a third party user.

In another aspect, the interface may be associated with an online marketplace.

In another aspect, the indicator may be includable on a page of the interface.

In another aspect, the indicator may be includable on a button displayed by the interface.

According to an embodiment of the present invention, a system may be provided for indicating transparency of information that includes an interface and an indicator. The indicator may include a first indication that signifies a level of openness and a second indication that signifies a level of independence. The indicator may be displayable by the interface to reflect the transparency of the information. The indicator may be determinable by performing the steps: (a) analyzing the information; (b) analyzing the level of independence; (c) analyzing the level of openness; (d) calculating the transparency using the level of independence and the level of openness; and (e) displaying the transparency as the indicator via the interface.

In another aspect, the information may relate to a review.

In another aspect, the information may be manipulable by a creator. The level of independence may be indicative of influence on the information by the creator.

In another aspect, the system may be operable on a computerized device with a processor and memory.

In another aspect, the level of openness may be indicative of availability of the information to a third party user.

In another aspect, the interface may be associated with an online marketplace.

In another aspect, the indicator may be includable on a page of the interface.

In another aspect, the indicator may be includable on a button displayed by the interface.

According to an embodiment of the present invention, a method may be provided relating to transparency of reviews using a system that includes an indicator and an interface. The method may include analyzing the reviews. The method may additionally include analyzing a level of independence indicative of influence on the review by a creator. Moreover, the method may include analyzing a level of openness indicative of availability of the reviews to a third party user. The method may include calculating the transparency using the level of independence and the level of openness. Furthermore, the method may include displaying the transparency as the indicator via the interface. The steps may be operable using a computerized device with a processor and memory.

In another aspect, the indicator may include a first indication reflecting the level of openness and a second indication reflecting the level of independence.

In another aspect, the level of independence may be negatively affected by modification of the review by the creator.

In another aspect, the indicator may be displayed on a page of the interface.

In another aspect, the indicator may be displayed on a button included by the interface.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIGS. 1-5 are diagrams illustrating a transparency indicator, according to an embodiment of the present invention.

FIG. 6 is a screenshot illustrating a profile page of an interface with a transparency indicator, according to an embodiment of the present invention.

FIG. 7 is a screenshot illustrating a personal home page of an interface with transparency indicators, according to an embodiment of the present invention.

FIG. 8 is a screenshot illustrating a watched page of an interface with a transparency indicator, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternative and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides a system and method to include a series of indicators on a website interface, page of the interface, buttons, or within an application to indicate the extent information, such as a review or rating, without limitation, has been manipulated. In other words, the system provides an indicator as to the transparency of information provided by third party users, which may be determined by analyzing a level of manipulation of that information by a creator of the page or listing. The system may provide interaction with one or more online interfaces, such as pages provided by a website. The interface may include a column or tab, entries within the column or tab, and other elements, through which content may be viewed and/or commented. The system and method may also disclose whether an owner of the account, page, column, or tab has modified or deleted any comments by third parties. The indicators may include numbers, colors, visual cues, and other features that can vary in accordance to changes in the options or parameters for the page, column, or tab in question. The changes may be a result of actions taken by the owner of the account, page, column, or tab owner.

The system may be operable on a computerized device with a processor and memory. The computerized device may communicate with a network connected device or another device that would be apparent to skilled artisans. An illustrative computerized device may include a processor, memory, and a network controller. Skilled artisans will additionally appreciate embodiments of a computerized device that may omit one or more of the aforementioned components, or include additional components, without limitation.

The processor may receive and analyze data. The memory may store data, which may be used by the processor to perform the analysis. The memory may also receive data indicative of results from the analysis of the data by the processor. The memory may include volatile memory modules, such as random access memory (RAM), or non-volatile memory modules, such as flash-based memory. Skilled artisans will appreciate the memory to additionally include storage devices, such as, for example, mechanical hard drives, solid state drives, and removable storage devices.

According to an embodiment of the present invention, a transparency review indicator system is provided that enables the selling or offering party to reflect an activity relating to review products and services being sold, offered, or otherwise exchanged. Additionally, present invention may provide a system and method that transparently reflects the status of a review for a product and virtually any revisions made to the same. The present invention may also provide a system to indicate a level of transparency relating to reviews and ratings caused by deletion or manipulation by a creator, which may be a selling or offering party. The present invention may provide a system that can transparently present a modification history of one or more reviews or ratings in an accessible and easily interpreted interface.

The present invention may facilitate interpretation of reviews and ratings relating to an online marketplace. The reviews may relate to products, goods, services, proposals, and/or ideas. The reviews may be assessed by others or to generate sales or exchanges between persons and organizations. The system may also provide a platform for collaboration among users.

Reviews are typically provided by third party users, or users other than persons or organizations creating the listing for products, goods, services, or putting forward proposals. Reviews by creators or proposers may be self-serving and would be given less weight than reviews provided by third parties or people independent from creators or proposers. Reviews may also be viewed by third party users. For the purpose of this disclosure, independence may relate to freedom from the control, influence, support, aid, or the like, of others. In practice, a level of independence of an individual or organization that is not immediately associated with the product or service being reviewed may vary from a high level of independence to a marginal level of independence to substantially no independence.

The level of perceived independence may depend on the extent of mental, physical or other connections, direct or indirect, between the reviewing party and the product or service being reviewed. The level of independence in editing and/or manipulating a review might lead to a review being presented that is not based on true beliefs of the reviewer or that may lead the reviewer to provide a review which is not objective. In an embodiment of the present invention, the system may operate one or more analyses, accessible using an interface, to provide meaningful and helpful reviews and to promote reviews with a high level of independence. The system may also adjust the level of independence of reviews and feedback from the creator or the proposer of the product or service being reviewed.

The system of the present invention may mitigate or eliminate a risk of false, biased, deliberately misleading, or malicious reviews submitted by users having a motive to promote or undermine one or more objective reviews or ratings. In particular, improper deletion, filtering, or manipulation of reviews may be intended to skew the perception of a third party relying on the review to make a purchasing decision. This risk exists even where the person or organization providing the review has purchased the product or service subject to the review being reviewed solely for providing access to a malicious reviewer with materials to make a false, biased, misleading or malicious review more convincing.

Websites that provide reviews may enable all of its users to draft and post reviews on product or service that can be acquired through the website. Where a purchase is involved, such review sites may limit comments to those who have purchased the product or service subject to the providing a review the user is providing. Some websites may require evidence of purchase before allowing a user to post a review. A variety of other mechanisms may be used to determine whether a review should be accepted, rejected, or given a weighted value.

According to an embodiment of the present invention, the system may provide information that can be displayed on an interface operated by the system, on a third party platform, and/or within a third party publication to indicate a level of openness for a reviewing user. As discussed above, the level of openness may be indicative of a user of the system, a third party platform, or an application that interacts with the system. The level of openness may relate to content of reviews from third parties, quantity of reviews from third parties, manipulation of reviews, or another aspect of the reviews that would be appreciated by a person of skill in the art. Additionally, the level of openness of the reviews may relate to an extent to which user reviews for products or services, thoughts, and ideas have been modified or deleted by the user of the third party platform or publication, for example a seller or a moderator.

Embodiments of the system may include a series of indicators in the form of a design or color scheme, text or other element on a website or within an application or publication. The indicator may reflect a first indication, such as a level of openness describing the extent to which it is possible to interact with a page, column, or tab and the entries within the same. The first indication may also reflect whether it is possible for particular users, or groups of users, to view and comment on the entries. Additionally, the indicator may reflect a second indication, such as a level of independence describing whether the owner of the account, page, column, or tab has deleted any comments by third parties and the numbers and types of comments deleted. The number of indicators, along with the way the indicators are illustrated in terms of size, shape, and the colors, may vary in accordance with the extent to which comments from particular third parties are original, manipulated, or deleted and in relation to changes in the options available for the page, column, or tab in question in terms of who is permitted to make comments.

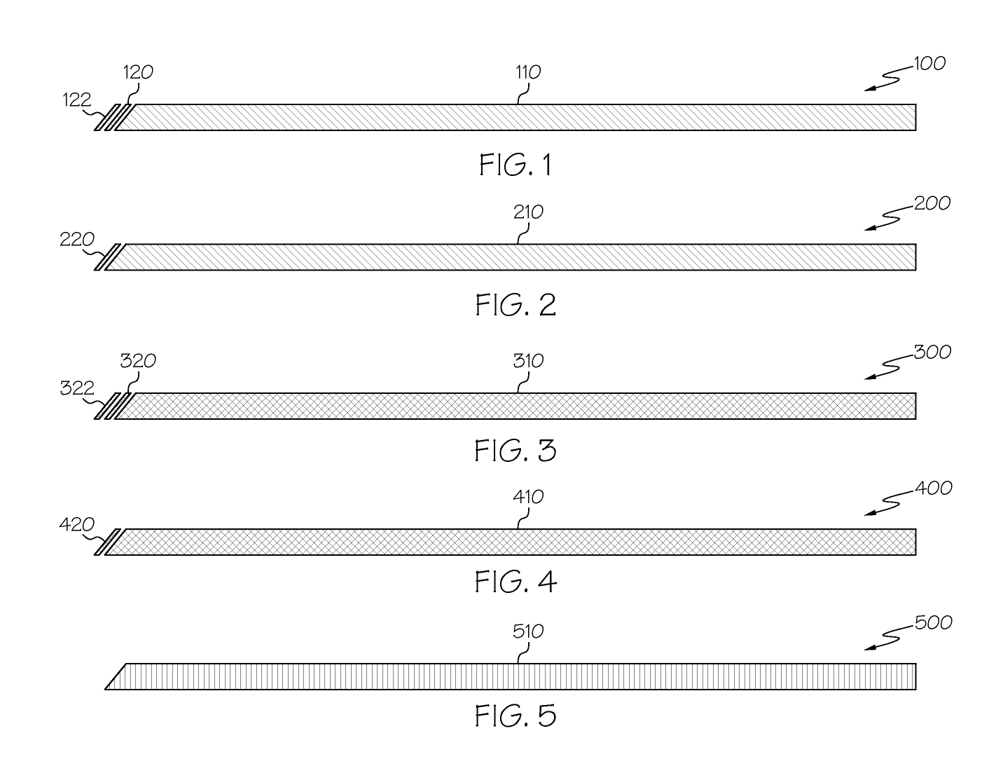

Referring now to FIGS. 1-8, an example of a set of indicators that could be used as part of a self-demonstrable transparency review indicator system will now be discussed. Those of skill in the art will appreciate that this example is being provided to clearly illustrate an embodiment of the present invention and is not intended to be limiting in any way. In this example, an interface is illustrated having an account page with one or more column or tabs within a website. The website may be included within an application provided by the system. Throughout this example, the term “tab” may refer to account, page, column, tab, or application. Additionally, the term “entry” may refer to any text, image, video, and/or sound entry made by the owner of the page.

Referring now to FIG. 1, a transparency indicator 100 depicting a tab with minimal manipulation will now be discussed. The indicator 100 may include a green strip 110 with double green stripes 120, 122 at one of its ends. The strip 110 may provide the first indication and the stripes 120, 122 may provide the second indication. In an alternative configuration, a dark green color may be used for the strip 110. Presence of this indicator 100 may reflect that the tab is viewable by everyone and that either no comment from a third party on anything for sale, offered, or wanted in that account, page, column, or tab has been deleted or, based on a comment algorithm included by the present invention, any comments that have been deleted are determined not to be significant enough to downgrade the authenticity of the tab. If it were determined that a downgrade was necessary, the indicator 100 may be modified to remove one of the green stripes 120, 122, as will be discussed below.

Referring now to FIG. 2, a transparency indicator 200 depicting a tab with notable manipulation will now be discussed. The indicator may include a green strip 210 with a single green stripe 220 at one of its ends. The strip 210 may provide the first indication and the stripe 220 may provide the second indication. In an alternative configuration, a light green color may be used for the strip 210. Presence of this indicator 200 may reflect that the tab is viewable by everyone and that either one or more comments from a third party on anything for sale, offered, or wanted in that account, page, column, or tab has been deleted or, based on a comment algorithm included by the present invention, at least one of the comments that have been deleted are determined to impact a perception of the product based on the reviews. The impact may be significant enough to downgrade the authenticity of the tab to reduce it to a single green stripe 220.

Referring now to FIG. 3, a transparency indicator 300 depicting a tab with restricted availability of viewing permissions and minimal manipulation will now be discussed. A restricted viewing permission may narrow the audience that may view the page to users allowed to watch the account, page, column, or tab. The strip 310 may provide the first indication and the stripes 320, 322 may provide the second indication. The indicator may include an amber strip 310 with double amber stripes 320, 322 at one of its ends. In an alternative configuration, a dark amber color may be used for the strip 310. Presence of this indicator 300 may reflect that the tab is viewable by the restricted group and that either no comment from a third party on anything for sale, offered, or wanted in that account, page, column, or tab has been deleted or, based on a comment algorithm included by the present invention, any comments that have been deleted are determined not to be significant enough to downgrade the authenticity of the tab. If it were determined that a downgrade was necessary, the indicator 300 may be modified to remove of one of the amber stripes 320, 322, as will be discussed below.

Referring now to FIG. 4, a transparency indicator 400 depicting a tab with restricted availability of viewing permissions and notable manipulation will now be discussed. As discussed above, a restricted viewing permission may narrow the audience that may view the page to users allowed to watch the account, page, column, or tab. The strip 410 may provide the first indication and the stripe 420 may provide the second indication. The indicator may include an amber strip 410 with a single amber stripe 420 at one of its ends. In an alternative configuration, a light amber color may be used for the strip 410. Presence of this indicator 400 may reflect that the tab is viewable by the restricted group and that one or more comment from a third party on anything for sale, offered, or wanted in that account, page, column, or tab has been deleted or, based on a comment algorithm included by the present invention, at least one of the comments that have been deleted are determined to impact a perception of the product based on the reviews. The impact may be significant enough to downgrade the authenticity of the tab to a single amber stripe 420.

Referring now to FIG. 5, a transparency indicator 500 depicting a tab with private viewing permissions will now be discussed. The indicator 500 may include a substantially solid red strip 510, which may provide the first indication. The private viewing indicator 500 may provide information that the related account, page, column, or tab is private.

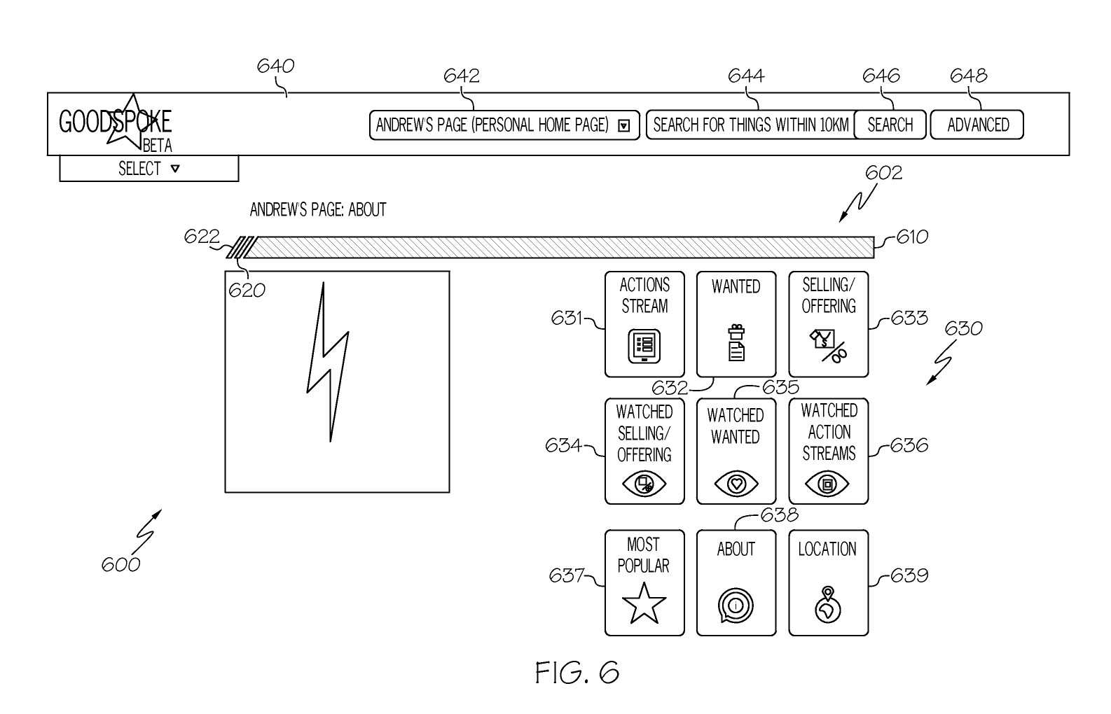

Referring to FIGS. 6-8, examples of an interface using various transparency indicators are provided in the interest of clarity, and without limitation. The transparency indicators may be determined using an analytical process performed by the system to examine reviews, manipulation or deletion of reviews, and influence to an outward perception of a product or service being offered due to any manipulation made to the reviews. The transparency indicators may be included in headers, buttons, titles, and/or other locations of an interface to convey a transparency of associated reviews or ratings.

Referring to FIG. 6, an example of an illustrative interface 600 will now be discussed. The interface 600 may include an indicator 602, buttons 630, and a navigation bar 640. The indicator 602 of this interface may include a strip 610 with a color indicative that the page is viable by substantially everyone, for example, green. The indicator 602 may include stripes 620, 622 to indicate no, or an insignificant number of, comments have been deleted, modified, or otherwise altered such to affect the transparency of information associated with the object.

The interface 600 may also include buttons 630, which may allow a user to navigate to additional parts of the interface. The buttons 630 may include an actions stream button 631, a wanted button 632, a selling/offering button 633, a watched selling/offering button 634, a watched wanted button 635, a watched action streams button 636, a most popular button 637, an about button 638, a location button 639, and additional buttons that may be appreciated by a person of skill in the art.

The interface 600 may additionally include a navigation bar 640. The navigation bar 640 may include a menu 642 to navigate throughout the interface. The navigation bar 640 may additionally include a search field 644 and associated search button 646. An advanced button 648 may be provided by the interface to provide enhanced features, such as filtered searching, advanced navigation, and additional other controls of the interface 640.

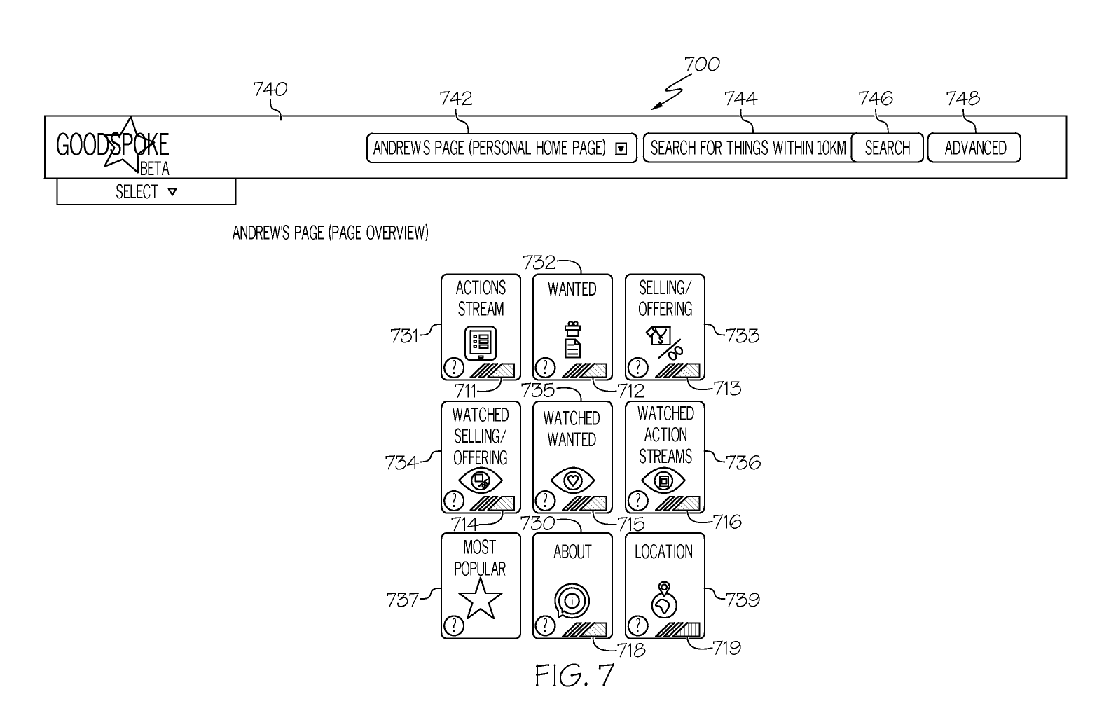

Referring to FIG. 7, an example of an illustrative interface 700 will now be discussed. The interface 700 may include buttons 730, indicators associated with the buttons, and a navigation bar 740. The buttons 730 may allow a user to navigate to additional parts of the interface. An actions stream button 731 may be included with an associated indicator 711 having a green first indication and two-stripe second indication. A wanted button 732 may be included with an associated indicator 712 having a green first indication and two-stripe second indication. A selling/offering button 733 may be included with an associated indicator 713 having a green first indication and two-stripe second indication. A watched selling/offering button 734 may be included with an associated indicator 714 having a green first indication and two-stripe second indication. A watched wanted button 735 may be included with an associated indicator 715 having a green first indication and two-stripe second indication. A watched action streams button 736 may be included with an associated indicator 716 having a green first indication and two-stripe second indication. A most popular button 737 may be included with no indicator. An about button 738 may be included with an associated indicator 718 having a green first indication and no second indication. A location button 739 may be included with an associated indicator 719 having a red first indication and no second indication. More buttons that may be appreciated by a person of skill in the art may be included by the interface 700, which may include additional associated indicators with various first and/or second indications.

The indicators of the buttons 730 of this interface may include respective strips, which may include a color indicative that the page is visible by substantially everyone, for example, green; a restricted audience, for example, amber; or a private audience, for example, red. The indicators may include stripes to indicate whether, an insignificant number of comments have been deleted, modified, or otherwise altered such to affect the transparency of the object.

The interface 700 may additionally include a navigation bar 740. The navigation bar 740 may include a menu 742 to navigate throughout the interface. The navigation bar 740 may additionally include a search field 744 and associated search button 746. An advanced button 748 may be provided by the interface to provide enhanced features, such as filtered searching, advanced navigation, and additional other controls of the interface 740.

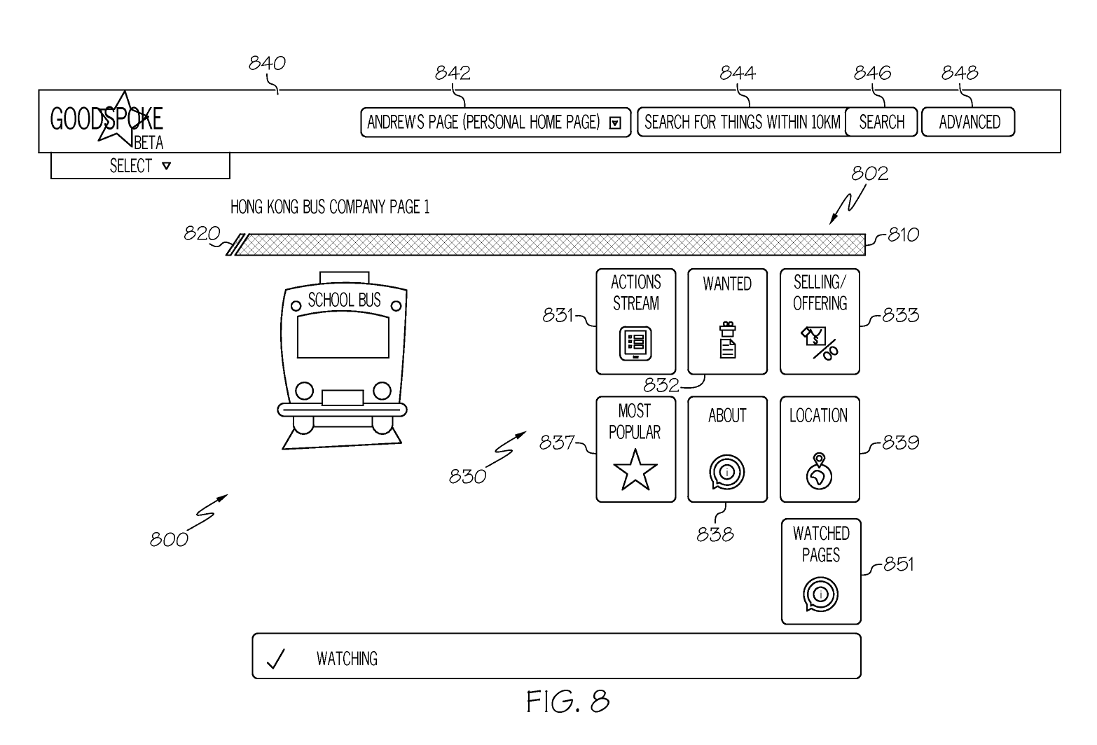

Referring to FIG. 8, an example of a watching page 800 of the interface will now be discussed. The page 800 may include an indicator 802, buttons 830, and a navigation bar 840. The indicator 802 of this interface may include a strip 810 with a color indicative that the page is viable by a restricted audience, for example, amber. The indicator 802 may include a stripe 820 to indicate a significant number of comments have been deleted, modified, or otherwise altered such to affect the transparency of the object that is subject of the page 800.

The page 800 may also include buttons 830, which may allow a user to navigate to additional parts of the interface. The buttons 830 may include an actions stream button 831, a wanted button 832, a selling/offering button 833, a most popular button 837, an about button 838, a location button 839, a watched pages button 851, and additional buttons that may be appreciated by a person of skill in the art.

The page 800 may additionally include a navigation bar 840. The navigation bar 840 may include a menu 842 to navigate throughout the interface. The navigation bar 840 may additionally include a search field 844 and associated search button 846. An advanced button 848 may be provided by the interface to provide enhanced features, such as filtered searching, advanced navigation, and additional other controls of the interface 840.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for indicating transparency of a review comprising:
an interface; and
an indicator comprising a first indication and a second indication being displayed by the interface to reflect the transparency of the review;
wherein the first indication signifies a level of openness;
wherein the second indication signifies a level of independence;
wherein the system is operable on a computerized device with a processor and memory.

2. The system of claim 1, wherein the review is manipulable by a creator, and wherein the level of independence is indicative of influence on the review by the creator.

3. The system of claim 1, wherein the indicator is determinable by performing the steps of:
(a) analyzing the review;
(b) analyzing the level of independence;
(c) analyzing the level of openness;
(d) calculating the transparency using the level of independence and the level of openness; and
(e) displaying the transparency as the indicator via the interface.

4. The system of claim 1, wherein the level of openness is indicative of availability of the review to a third party user.

5. The system of claim 1, wherein the interface is associated with an online marketplace.

6. The system of claim 1, wherein the indicator is includable on a page of the interface.

7. The system of claim 1, wherein the indicator is includable on a button displayed by the interface.

8. A system for indicating transparency of information comprising:
an interface;
an indicator comprising a first indication that signifies a level of openness and a second indication that signifies a level of independence being displayable by the interface to reflect the transparency of the information;
wherein the indicator is determinable by performing the steps of:
(a) analyzing the information;
(b) analyzing the level of independence;
(c) analyzing the level of openness;
(d) calculating the transparency using the level of independence and the level of openness; and
(e) displaying the transparency as the indicator via the interface.

9. The system of claim 8, wherein the information relates to a review.

10. The system of claim 8, wherein the information is manipulable by a creator, and wherein the level of independence is indicative of influence on the information by the creator.

11. The system of claim 8, wherein the system is operable on a computerized device with a processor and memory.

12. The system of claim 8, wherein the level of openness is indicative of availability of the information to a third party user.

13. The system of claim 8, wherein the interface is associated with an online marketplace.

14. The system of claim 8, wherein the indicator is includable on a page of the interface.

15. The system of claim 8, wherein the indicator is includable on a button displayed by the interface.

16. A method for providing transparency of reviews using a system comprising an indicator and an interface, the method comprising the steps of:
(a) analyzing the reviews;
(b) analyzing a level of independence indicative of influence on the review by a creator;
(c) analyzing a level of openness indicative of availability of the reviews to a third party user;
(d) calculating the transparency using the level of independence and the level of openness; and
(e) displaying the transparency as the indicator via the interface;
wherein the steps are operable using a computerized device with a processor and memory.

17. The method of claim 16, wherein the indicator comprises a first indication reflecting the level of openness and a second indication reflecting the level of independence.

18. The method of claim 16, wherein the level of independence is negatively affected by modification of the review by the creator.

19. The method of claim 16, wherein step (e) further comprises displaying the indicator on a page of the interface.

20. The method of claim 16, wherein step (e) further comprises displaying the indicator on a button included by the interface.
